(19) United States
(12) Patent Application Publication
(10) Pub. No.: US 2025/0004490 A1
(43) Pub. Date: Jan. 2, 2025

(54) VOLTAGE COMPENSATION FOR REDUCED POWER STATES

(71) Applicant: Intel Corporation, Santa Clara, CA (US)

(72) Inventors: Yoni AIZIK, Haifa (IL); Yevgeni SABIN, Haifa (IL); Sagi WEISS, Binyamina (IL); Dor ZVIK, Herzelia (IL); Itai FEIT, Ramat Hasharon (IL); Lisa EZRA, Kfar Saba (IL); Yossi BEN SIMON, Karmiel (IL); Nir MISGAV, Ein Hahoresh (IL); Yulia OKUNEV, Tirat Carmel (IL); Arik GIHON, Rishon Le Zion (IL); Yoav BABAJANI, Rishon Le Zion (IL); Pavel MIKHLIN, Raanana (IL)

(21) Appl. No.: 18/217,393

(22) Filed: Jun. 30, 2023

(51) Int. Cl. G05F 1/46

(52) U.S. Cl. CPC G05F 1/46

(57) ABSTRACT

Presented are temperature-monitoring supply voltage compensation techniques. Some techniques allow for a supply voltage to be monitored and compensated during a reduced power state, even when a control unit circuit that controls the supply voltage is in the reduced power state.

### TECHNICAL FIELD

Embodiments of the invention relate to the field of integrated circuits; and more specifically, to managing supply levels during reduced power states.

### BRIEF DESCRIPTION OF THE DRAWINGS

The invention may best be understood by referring to the following description and accompanying drawings that are used to illustrate embodiments of the invention. In the drawings:

FIG. 1 is a block diagram of an integrated circuit (IC) having reduced power state temperature aware voltage supply management in accordance with some embodiments.

FIG. 2 is a block diagram showing a thermal sense unit (TSU) and control unit in accordance with some embodiments.

FIG. 3 is a flow diagram showing a routine for implementing ITD compensated voltage supply control in accordance with some embodiments.

FIG. 4 is a graph showing an inverse temperature dependency relationship between required compensating voltage offset and temperature for an exemplary transistor type in accordance with some embodiments.

FIG. 5 is a block diagram showing a processor having an ITD compensated supply voltage in accordance with some embodiments.

FIG. 6 is a block diagram of an IC 600 with an ITD compensated voltage supply in accordance with some additional embodiments.

FIG. 7 is a block diagram of a computing system platform in accordance with some embodiments.

FIG. 8 is a diagram of a processor for the computing system of FIG. 7 in accordance with some embodiments.

### DETAILED DESCRIPTION

With advanced process transistors such as those with process features of 10 nm and below, there may be an inverse relationship between temperature and the required transistor supply voltage needed to achieve a certain operational performance capability. Lower temperatures cause circuits formed from such transistors to operate more slowly. Under normal operation, logic (e.g., power management unit) is typically used to control many of the voltage rails to track circuit temperature to adjust supply voltages to compensate for temperature changes. As a circuit gets colder, its supply voltage is increased, while its supply voltage is typically decreased as the circuit gets warmer.

Unfortunately, when processors go into some reduced power states (RPS), there still may be some voltage rails that need to be maintained. In some of these states, the VR control logic may be shut down with some of the voltage rails staying on at predefined levels, or allowable ranges, usually set by the VR control logic prior to exiting its active state. Given that the purpose of the reduced power state is to reduce power, circuit block temperatures will normally go down, in many cases, at a fairly fast rate, which creates a need for a compensating increased supply voltage.

To address this, platforms commonly estimate the reduced power state (RPS) duration and apply voltage compensation assuming the circuitry serviced by the rails that remain active will go down to worst case temperatures. This usually works to maintain proper circuit functionality, but it also leads to voltage overcompensation and hence to wasteful additional power consumption during the reduced power state. Accordingly, temperature-monitoring IDT supply voltage compensation techniques addressing these challenges are provided in accordance with some embodiments.

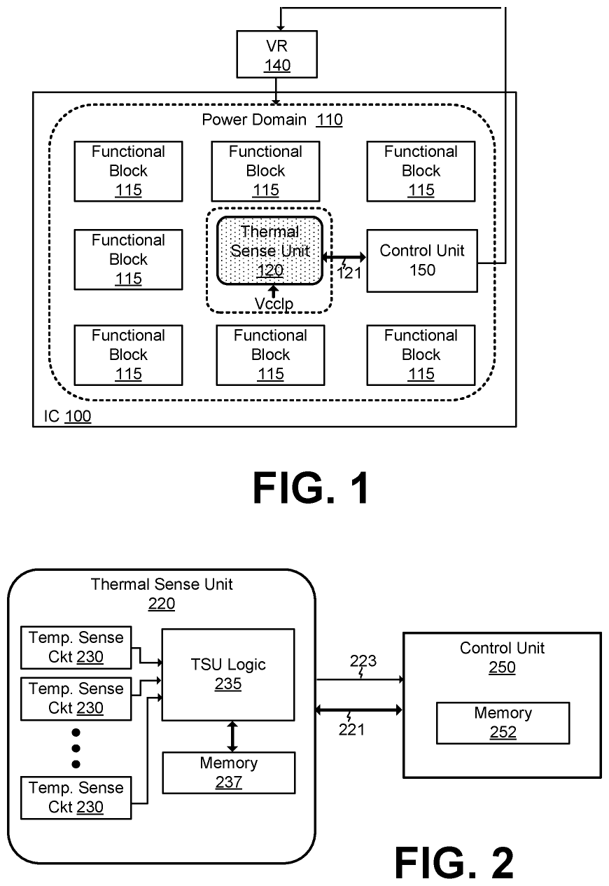

FIG. 1 is a block diagram of an integrated circuit (IC) having reduced power state temperature aware voltage supply management in accordance with some embodiments. IC 100 has at least one power domain 110 comprising functional circuit blocks 115 and a control unit 150. Also shown is a voltage regulator (VR) 140 to provide a voltage supply (Vcc) to the power domain 110 in order to provide supply voltages to the functional blocks and to the control unit 150. (Note that any of these components may also receive power from other supplies, which may operate apart from, or in addition with, VR 140, e.g., for different operational modes.) While the control unit 150 is shown as being part of voltage domain 110, it could be in a separate domain or be in multiple domains including domain 110.) The IC 100 may be any suitable processing or processing support device implemented with one or multiple semiconductor dies. For example, it could be a processor such as a central processing unit (CPU), system on chip (SOC), graphics processing unit (GPU), field programmable gate array (FPGA), application specific integrated circuit (ASIC) memory, or the like.

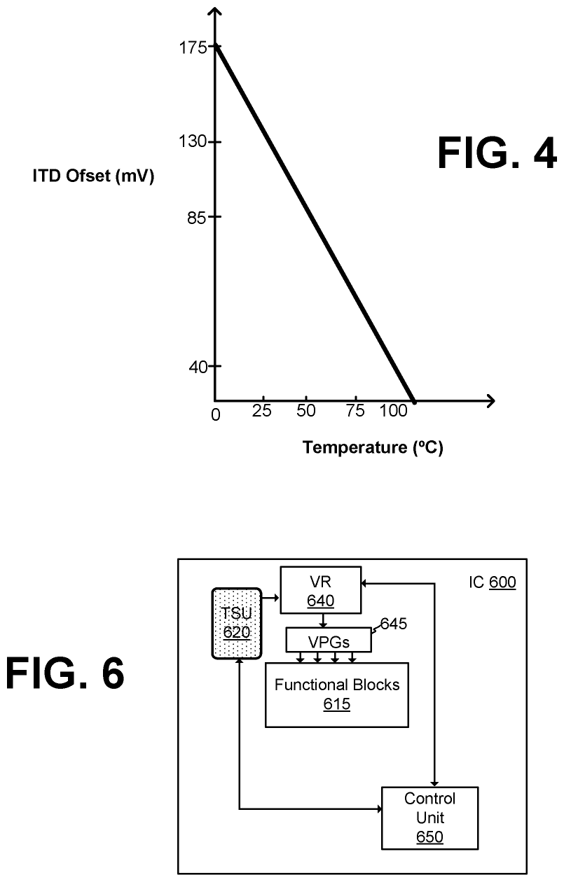

The IC 100 also includes a thermal sense unit (TSU) 120 to monitor temperature for the circuit elements within power domain 110. In the depicted embodiment, the TSU 120 is powered from a different supply (Vcclp) than power domain 110, which allows it to operate even when the domain is in a reduced power state. TSU 120 is coupled to control unit 150 through signal line(s) 121. As indicated, control unit 150 is also coupled to VR 140 to control, among other things, the voltage level provided to the power domain 110. In doing this, it takes into account the temperature measured by TSU 120. For example, it might apply an ITD (inverse temperature dependency) offset based on a monitored temperature in accordance with the voltage/temperature curve shown in FIG. 4.

In some embodiments, the power domain may be placed in a reduced power state where control unit 150 is to be inactive but where some of the functional blocks 115 are to remain working. In such cases, since power is being reduced, the temperature in the domain circuitry may go down. Since some of the functional blocks are still working, the VR supply should account for the reduced temperature even though the control unit is inactive.

Accordingly, in order to avoid having to over-compensate for worst-case scenarios by fixing the VR at an expected worst-case level, the TSU 120 continues to monitor temperature and wakes up the control unit 150 when the temperature crosses a predefined threshold or range. In this way, a less conservative supply voltage may be set before entering the reduced power mode.

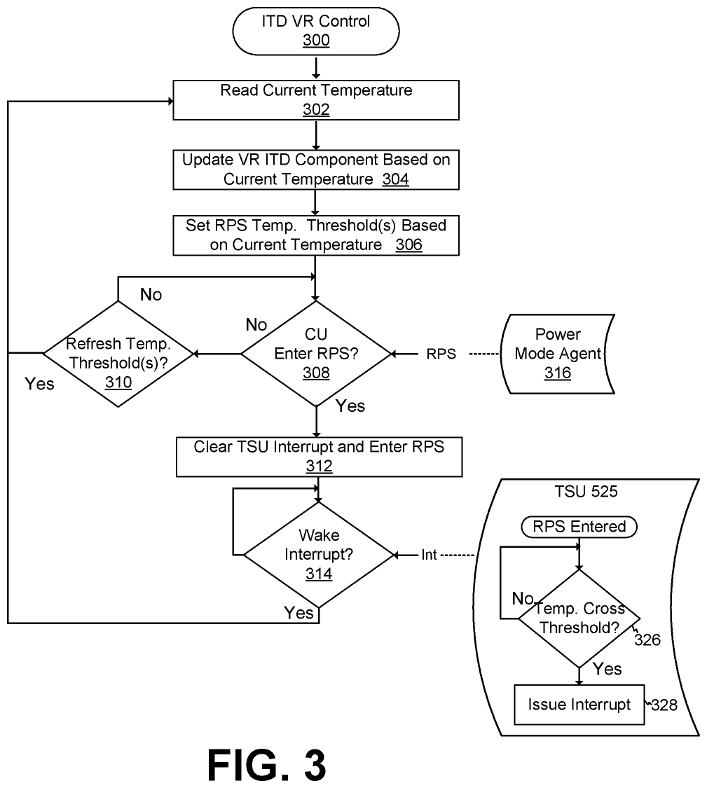

FIG. 2 is a block diagram showing a TSU 220 coupled to a control unit 250 through communications and interrupt lines 221, 223, respectively, in accordance with some embodiments. Control unit 250 may be implemented with any logic circuit or logical circuit block used for controlling a voltage regulator supply level. In some cases, it may correspond to a power management unit (PMU), power control unit (PCU), system agent, p-unit, or system management unit (SMU) used for monitoring and controlling various functions such as supplied power, power state management, performance monitoring, peripheral interfaces, boot operations, and/or other functions, depending on the particular processing device platform. It may have one or more micro-controllers, state machines, converters, timers, and/or memory such as firmware to perform such functions. In the depicted embodiment, it includes memory 252 to execute code to, among other things, perform a routine such as the routine in the flow diagram of FIG. 3, which will be discussed below.

Thermal sense unit 220 includes one or more temperature sensor circuits 230, TSU logic 235, and memory 237, coupled together as shown. The temperature sensor circuits 230 include temperature sense elements configured to generate electrical signals used by temperature sense interface circuitry within each temperature sensor circuit to generate digital output signals indicative of their sensed temperatures. The sense elements are disposed within the IC and at least some of them likely will be located sufficiently near the power domain functional block circuitry to provide meaningful temperature information. The temperature sensor circuits 230 may be implemented with any suitable integrated circuit temperature sense solutions. For example, configurations using resistors, thermistors, diodes and/or transistors or combinations of the same could be employed. A popular integrated circuit approach is to use transistor/diode configurations that employ band gap reference techniques. Ideally, low power approaches compatible with FinFET or GAA-FET (gate all around FET) processes may be employed when building ICs from these transistor device types. There may be several different suitable low-power solution types available. For example, U.S. Pat. No. 11,609,127 to Eberlein (incorporated by reference herein) discloses a switch capacitor temperature sensor that may be suited for some implementations. In another approach, a thermal sense circuit using a subthreshold metal oxide semiconductor (MOS) transistor and a PNP parasitic Bi-polar Junction Transistor (BJT) device to form a reverse BGR is presented in U.S. Pat. Pub. No. 2022/0100221 to Duarte et al., filed on Sep. 25, 2020 and incorporated by reference herein. It should be appreciated that these, or any other suitable temperature sensing techniques, could be employed.

The digital temperature signals from temperature sensor circuits 230 are provided to the TSU logic 235, which may use one, some or all of these temperature values to generate an aggregate temperature value to be provided to control unit 250 through communications interface 221. For example, the TSU logic 235 could use the lowest value, an average value, or a combination of one or more of the values, e.g., depending on where the sensors are located and what functional blocks are being operated. Alternatively, it could provide the different sensor values separately, staggered over time in order to provide the control unit with more granular access to the sensed temperature points within the IC.

The temperature signal provided to the control unit may be sent periodically, in response to a request from the control unit, or it could be made available as it updates, e.g., using a mailbox scheme whereby it is placed in a memory element such as a register and made available to the control unit, as well as possibly to other agents in the IC. The communications interface 221 may be implemented with any suitable signal structure such as by using serial or parallel lines through a point-to-point, bus, or fabric interconnection scheme, although it is contemplated that in some embodiments, the TSU 220 may be designed to consume as little power as may be tolerated to achieve required performance objectives.

In some embodiments, the TSU 220 is programmable, e.g., by control unit 250. For example, the control unit may update TSU operating parameters, temperature thresholds or ranges, and other runtime parameters. As will be addressed in greater detail below, before going offline in certain reduced power modes, the control unit may program the TSU with an operating reduced temperature threshold (with a lower temperature level) or a range (with both upper and lower threshold levels) to monitor sensed temperature and to issue a wake interrupt through interrupt line 223 to the control unit 250 when a threshold has been crossed. From here, the control unit may read the current temperature, change the VR supply voltage accordingly, and if set to go back into the reduced power state, re-program the TSU with one or more new threshold levels to monitor. In some embodiments, the interrupt line is implemented with a single wake line configured to wake the control unit, which may include wake interrupt circuitry to service the interrupt when it is in the reduced power mode. This circuitry could be part of the control unit or part of some other component of the platform. Along these lines, while the interrupt line 223 is shown as being separate from the communications interface 221, the signals could be implemented using the same physical line or lines, depending on particular design concerns regarding the selection of a particular communications link architecture.

FIG. 3 is a flow diagram showing a routine for implementing ITD compensated voltage supply control in accordance with some embodiments. For example, this routine may be implemented as part of executing code in a control unit such as control unit 250. To start, the routine reads a current temperature value from a TSU. Next, at 304, it updates, if necessary, an ITD component (or aspect) of a voltage level to be provided by a VR. For example, it might apply an offset from a curve such as that illustrated in FIG. 4 to a voltage setting that may consider one or several other factors such as platform conditions, operating states, load-line settings, OS requests, error margins, etc. In some embodiments, a control unit considers these factors and calculates a resultant voltage to be requested from the VR. For ITD compensation, a simple offset may be applied, or the control unit may use the received current temperature value to inform a resultant voltage derivation using any other suitable formulation or, for example, as part of an index or argument to retrieve a VR value from a look-up table or the like.

AT 306, the routine sets (or defines) one or more RPS temperature threshold levels based on the current temperature. For example, it might define a low threshold, 10 degrees below the current temperature, or it may define both a lower threshold and an upper threshold, e.g., 5 degrees below and 10 degrees above the current temperature. It may convey these levels to the TSU, or it may simply maintain a running threshold level to be applied when/if needed.

At 308, if the control unit is not to enter (or be in) a reduced power state (RPS), then it proceeds to 310 and determines if the temperature threshold(s) are to be refreshed, e.g., because of a change in the current temperature, an elapsed timer from the previous update or some other event. If so, the routine goes back to 302 and processes as previously described. On the other hand, if at 310, the routine determines that a threshold refresh is not needed, then it loops back to 308 and runs in this loop until either a threshold refresh is needed or until it is directed by a power mode agent 316 to enter into a reduced power state. A power mode agent may be any entity in a compute or processing platform with authority and ability to cause a control unit (or any other device executing this routine) to enter into a reduced power state in accordance with the concepts of this disclosure.

At 308, if the routine determines it is to go into a reduced power state, then at 312, it clears any previously set TSU interrupts, sets the VR voltage to an appropriate level, and goes into the reduced power state. (It may, and likely will, take other actions that are not necessarily part of the main focus of this disclosure. For example, it may define VR levels that functional blocks still online may request from the VR on their own accord. If they need voltage levels outside of the range, they might be required to wake up the control unit to service the request.) At 314, the routine is in the reduced power state. A loop is shown here to indicate the wait status for clarity and convenience, but there may not actually be any executing loop, at least within the control unit. For example, a control unit might be dormant until awoken by an interrupt such as an interrupt, as shown, from a TSU 325.

At 325, a flow is shown for TSU when it is enabled to monitor temperature during a reduced power state for the control unit. At 326, the TSU monitors whether or not the temperature (e.g., resultant TSU temperature) crosses a threshold as set by the control unit. If the threshold is only for a lowered temperature, then it stays in this loop until, if at all, the monitored temperature goes below this threshold. If it does, then the TSU issues a wake interrupt to the control unit at 314. Similarly, if high and low thresholds were set by the control unit, then at 326, the control unit would proceed to 327 and issue an interrupt if the monitored temperature goes either above the high threshold or below the low threshold. When an interrupt is issued, the control unit routine returns back to 302 and proceeds as previously described. It reads from the TSU the current temperature, controls the VR accordingly, and sets new TSU temperature threshold(s). It proceeds to 308 and essentially waits for the next RPS entry while keeping the current temperature settings up to date. Note that if it had just serviced a TSU interrupt, it may immediately go back into a reduced power state at 308, e.g., because a flag in the control unit or from the power mode agent could still be set.

In some embodiments, different threshold level formulations could be used to provide wider or narrower threshold ranges and vary, for example, depending on the value of a current temperature. For finer IDT compensation, more threshold sets with narrower ranges could be used. Alternatively, in order to have less interrupt events, wider threshold ranges and thus fewer possible thresholds could be employed. For example, assume that the relevant IC portion is expected to operate within a temperature range of between 0 and 100 degrees C., with a normal, expected operating temperature being at around 40 degrees C. The low threshold levels could be (1) 5 degrees below current temperature for current temperatures between 35 and 45 degrees C., (2) 10 degrees below current temperature for current temperatures below 35 degrees C. or between 45 and 60 degrees C., and (3) 20 degrees below current temperature for current temperatures above 60 degrees C. If used, high threshold levels could be applied similarly, although they may involve different considerations since power domains typically should not typically have increased temperatures when in reduced power states. However, this is possible, for example, if neighboring domains are running hot or if the IC, as a whole, is being operated in a higher temperature environment.

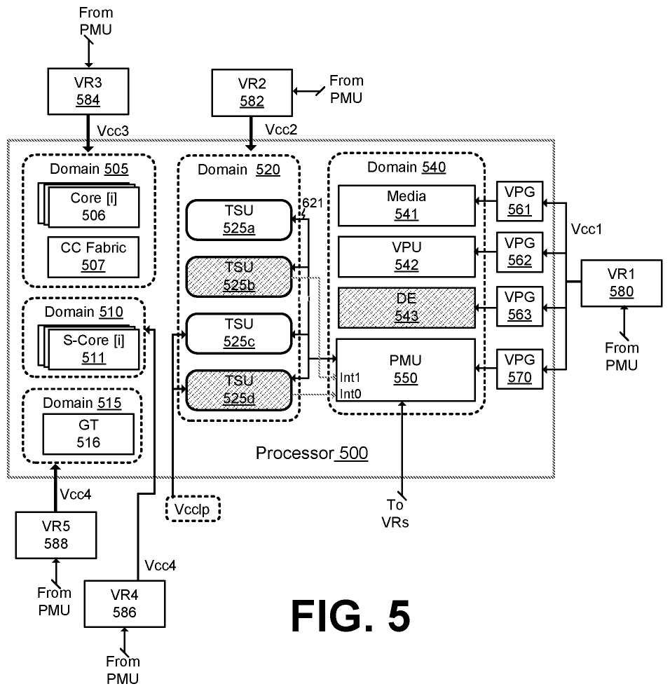

FIG. 5 is a block diagram showing a processor 500 having ITD compensated supply voltage in accordance with some embodiments. As with the IC of FIG. 1, processor 500 may be part of a single die or implemented with several dies, e.g., in a multi-chip system or module. Processor 500 includes several different power domains including a CPU core complex domain 505, a smaller cores domain 510, a graphics technology domain 515, a low power device domain 520, with TSUs 525, and an IP blocks domain 540, which in this depiction, includes a Media block 541, video processing unit (VPU) 542, Display engine (DE) 543, and power management unit (PMU) 540.

The processor 500 also includes variable power gates 561, 562, 563, and 570 to provide separate voltage supplies to the IP blocks in IP domain 540 from VR1, which is controlled by the PMU 550. Other voltage regulators, VR2 through VR5, are included to provide associated voltage supplies to the other domains, with the exception of low power domain 520, which receives power from a separate lower power source. In addition to VR1, the other VRs, VR2 through VR5, are controlled by PMU 550. In some embodiments, VR1 through VR5 are powered from, or part of, a common VR system such as a serial voltage ID (SVID) supply, which itself, may be powered from an AC-DC converter, a battery system, or both a converter and battery system.

The variable power gates are power gates that can operate also as linear regulators such as low drop-out (LDO) or DLVR (digital linear voltage regulator) regulators. In this way, they can gate off their associated IP blocks in deep reduced power states, as with power gates alone, or they can provide variable voltage levels in accordance with operating modes of their IP blocks. They also have a pass-through mode where they function like turned-on power gates, passing the voltage from VR1 through to their IP block. this can be convenient, for example, when the PMU is in a reduced power state but one or more IP blocks in domain 540 are still active.

Many compute platforms use power management schemes whereby different platform components may be in various levels of activity or inactivity, depending on the current use scenario. For example, when cores (CPU big, CPU small, graphics, etc.) are active, they may be operated at different operating voltage/frequency points depending on system priorities and the apps that are running. When all or most cores, e.g., when the CPU cores are idle, then various other parts of a processor such as cache and other blocks may be inactivated.

As an example, many compute platforms use embodiments of the Advanced Power and Configuration Interface (ACPI) specification, which defines different activity (or inactivity) states for CPU cores (P states) and the processor package (C states), as well as for other aspects of a compute system. For example, when a processor is idle (e.g., CPU core complex cores are inactive), lower power C-states may be used to save power, with more aggressive power savings actions occurring with numerically higher C-states. In fact, some of the higher C states such as C6 through C10 may be so-called deep C states. In some implementations of these deep C states, much of a processor may be inactive. An example is illustrated in FIG. 5 where all of the blocks, including the PMU, are inactive except for the display engine 543 and selected TSUs (525b, 525d). For example, in some operating modes, a compute platform such as a laptop might be relatively inactive, but it still may be desirable to keep its display turned on, displaying frames that are accessible to the display engine 543. Opportunities for entering this reduced power state may be more common than one might intuit because such states may only have to last for milli-seconds or tens of milli-seconds to be worthwhile in terms of entry/exit latency costs.

When processor 500 is in an active state, the four TSUs 525, which may be distributed within the processor, or within a region of the processor, are on, providing monitored temperature values to the PMU by way of a communications interface 521. However, when the processor goes into the depicted reduced power state (e.g., deep sleep state), the PMU goes into a sleep mode, as is shown. Before doing so, however, it selects two of the TSUs to remain on to monitor temperature for providing VR1 with ITD compensation. For example, it might select the two worst case (potentially “coldest”) TSUs based on their locations. From here, the PMU may execute a routine such as is shown in the flow diagram of FIG. 3, as has been previously described. Here, however, there are two active TSUs. Before entering its sleep state, the PMU programs both TSUs with temperature thresholds that may be the same or may be different for each TSU. It goes to sleep and if neither TSU threshold (or threshold range when both low and high thresholds are used) is tripped, it may remain inactive with VR1 kept at its pre-sleep state level. On the other hand, if either TSU temperature crosses a threshold, then it asserts an interrupt to the PMU to awaken it. The PMU reads the current temperature from the tripped TSU, adjusts VR1 accordingly, redefines TSU threshold levels for both TSUs, clears any interrupts and returns back into the sleep state if it is otherwise to remain in this state.

FIG. 6 is a block diagram of an IC 600 with an ITD compensated voltage supply in accordance with some additional embodiments. The processor includes functional blocks 615 that receive supply voltages from a VR 640 through variable power gates 645. The VR 640 is shown as being part of the IC 600, but it should be appreciated that it may or may not be part of the processor 600 itself. For example, processor 600 could be implemented in a processor package with one or more dies, and the VR 640 could be located on a common printed circuit board (PCB) or motherboard (MB), or it could be wholly, or partially, integrated as part of the processor package.

The processor also includes a TSU 620 and a control unit 650 as shown. With this embodiment, however, instead of waking up the PMU to service the VR when it detects that a temperature crosses a threshold, the TSU instead might issue an interrupt to the VR itself to cause it to adjust its voltage supply level. Alternatively, the TSU might not even employ thresholds in this way, instead, providing to the VR an ITD compensation value to be either periodically read by the VR during a reduced power state or read in response to an interrupt or to another event.

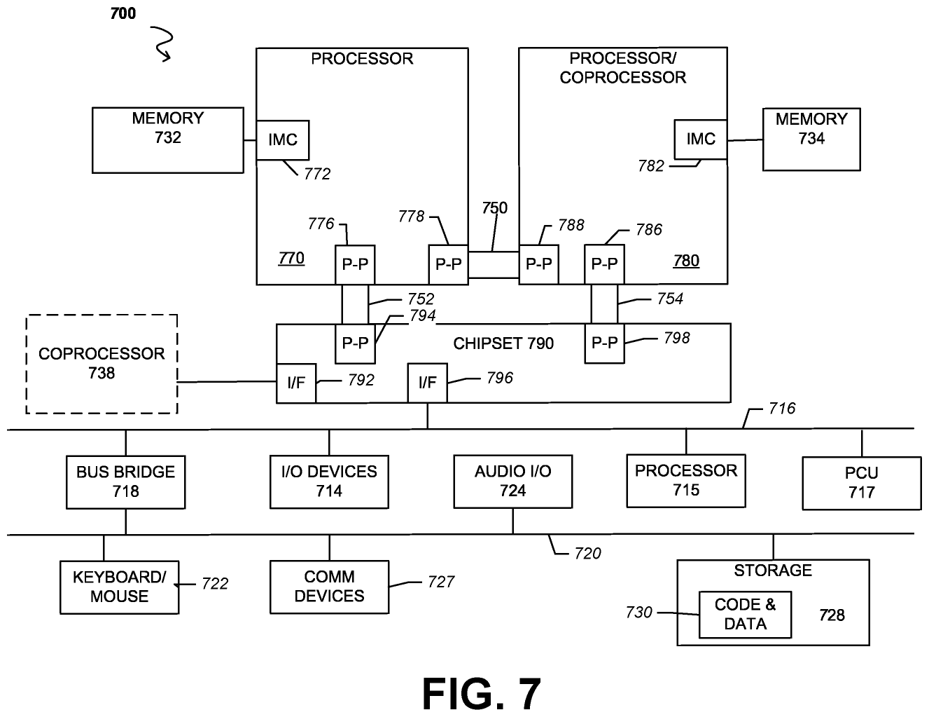

FIG. 7 illustrates an example computing system. Multiprocessor system 700 is an interfaced system and includes a plurality of processors including a first processor 770 and a second processor 780 coupled via an interface 750 such as a point-to-point (P-P) interconnect, a fabric, and/or bus. In some examples, the first processor 770 and the second processor 780 are homogeneous. In some examples, first processor 770 and the second processor 780 are heterogenous. Though the example system 700 is shown to have two processors, the system may have three or more processors, or may be a single processor system. In some examples, the computing system is implemented, wholly or partially, with a system on a chip (SoC) or a multi-chip (or multi-chiplet) module, in the same or in different package combinations.

Processors 770 and 780 are shown including integrated memory controller (IMC) circuitry 772 and 782, respectively. Processor 770 also includes interface circuits 776 and 778, along with core sets. Similarly, second processor 780 includes interface circuits 786 and 788, along with a core set as well. A core set generally refers to one or more compute cores that may or may not be grouped into different clusters, hierarchal groups, or groups of common core types. Cores may be configured differently for performing different functions and/or instructions at different performance and/or power levels. The processors may also include other blocks such as memory and other processing unit engines. In addition, the core set and other blocks may be part of one or more different power supply domains having VRs with TSUs and voltage supplies with ITD compensation in accordance with any of the embodiments disclosed herein.

Processors 770, 780 may exchange information via the interface 750 using interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a network interface (NW I/F) 790 via individual interfaces 752, 754 using interface circuits 776, 794, 786, 798. The network interface 790 (e.g., one or more of an interconnect, bus, and/or fabric, and in some examples is a chipset) may optionally exchange information with a coprocessor 738 via an interface circuit 792. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 770, 780 or outside of both processors, yet connected with the processors via an interface such as P-P interconnect, such that either or both processors' local cache information may be stored in the shared cache if a processor is placed into a low power mode.

Network interface 790 may be coupled to a first interface 716 via interface circuit 796. In some examples, first interface 716 may be an interface such as a Peripheral Component Interconnect (PCI) interconnect, a PCI Express interconnect, or another I/O interconnect. In some examples, first interface 716 is coupled to a power control unit (PCU) 717, which may include circuitry, software, and/or firmware to perform power management operations with regard to the processors 770, 780 and/or co-processor 738. PCU 717 provides control information to one or more voltage regulators (not shown) to cause the voltage regulator(s) to generate the appropriate regulated voltage(s). In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. For example, such a PCU 717 may operate in accordance with a control unit as disclosed herein to manage ITD supply voltage compensation. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software. Along these lines, power management may be performed in concert with other power control units implemented autonomously or semi-autonomously, e.g., as controllers or executing software in cores, clusters, IP blocks and/or in other parts of the overall system, and any of these other control units may operate in accordance with techniques described herein for controlling supply levels during reduced power states.

Various I/O devices 714 may be coupled to first interface 716, along with a bus bridge 718 which couples first interface 716 to a second interface 720. In some examples, one or more additional processor(s) 715, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 716. In some examples, second interface 720 may be a low pin count (LPC) interface. Various devices may be coupled to second interface 720 including, for example, a keyboard and/or mouse 722, communication devices 727 and storage circuitry 728. Storage circuitry 728 may be one or more non-transitory machine-readable storage media as described below, such as a disk drive or other mass storage device which may include instructions/code and data 730 and may implement the storage in some examples. Further, an audio I/O 724 may be coupled to second interface 720. Note that other architectures than the point-to-point architecture described above are possible. For example, instead of the point-to-point architecture, a system such as multiprocessor system 700 may implement a multi-drop interface or other such architecture.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

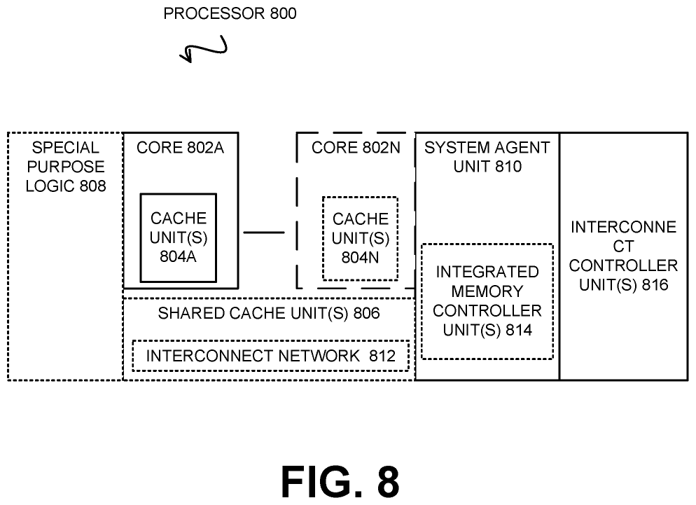

FIG. 8 illustrates a block diagram of an example processor and/or SoC 800 that may have one or more cores and an integrated memory controller. The solid lined boxes illustrate a processor 800 with a single core 802(A), system agent unit circuitry 810, and a set of one or more interface controller unit(s) circuitry 816, while the optional addition of the dashed lined boxes illustrates an alternative processor 800 with multiple cores 802(A)-(N), a set of one or more integrated memory controller unit(s) circuitry 814 in the system agent unit circuitry 810, and special purpose logic 808, as well as a set of one or more interface controller units circuitry 816. Note that the processor 800 may be one of the processors 770 or 780, or co-processor 738 or 715 of FIG. 7.

Thus, different implementations of the processor 800 may include: 1) a CPU with the special purpose logic 808 being integrated graphics and/or scientific (throughput) logic (which may include one or more cores, not shown), and the cores 802(A)-(N) being one or more general purpose cores (e.g., general purpose in-order cores, general purpose out-of-order cores, or a combination of the two); 2) a coprocessor with the cores 802(A)-(N) being a large number of special purpose cores intended primarily for graphics and/or scientific (throughput); and 3) a coprocessor with the cores 802(A)-(N) being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804(A)-(N) within the cores 802(A)-(N), a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples interface network circuitry 812 (e.g., a ring interconnect) interfaces the special purpose logic 808 (e.g., integrated graphics logic), the set of shared cache unit(s) circuitry 806, and the system agent unit circuitry 810, alternative examples use any number of well-known techniques for interfacing such units. In some examples, coherency is maintained between one or more of the shared cache unit(s) circuitry 806 and cores 802(A)-(N). In some examples, interface controller units circuitry 816 couple the cores 802 to one or more other devices 818 such as one or more I/O devices, storage, one or more communication devices (e.g., wireless networking, wired networking, etc.), etc.

In some examples, one or more of the cores 802(A)-(N) are capable of multi-threading. The system agent unit circuitry 810 includes those components coordinating and operating cores 802(A)-(N). The system agent unit circuitry 810 may include, for example, power control unit (PCU) circuitry and/or display unit circuitry (not shown). The PCU may be or may include logic and components needed for regulating the power state of the cores 802(A)-(N) and/or the special purpose logic 808 (e.g., integrated graphics logic). The PCU, in cooperation with one or more VRs and TSUs, may also perform ITD compensated voltage control for at least some of the VRs in accordance with the techniques described herein. The display unit circuitry is for driving one or more externally connected displays.

The cores 802(A)-(N) may be homogenous in terms of instruction set architecture (ISA). Alternatively, the cores 802(A)-(N) may be heterogeneous in terms of ISA; that is, a subset of the cores 802(A)-(N) may be capable of executing an ISA, while other cores may be capable of executing only a subset of that ISA or another ISA.

### Example Embodiments

Illustrative examples of the technologies disclosed herein are provided below. An embodiment of the technologies may include any one or more, and any compatible combination of, the examples described below.

Example 1 is an apparatus that includes an integrated circuit (IC). The IC includes a thermal sense unit (TSU) and a control unit. The TSU is to generate a sensed temperature value. The control unit is coupled to the TSU to control a supply voltage based on the sensed temperature value. The TSU is to cause the supply voltage to be adjusted to compensate for a sufficient change in the sensed temperature value when the control unit is not controlling the supply voltage during a reduced power state.

Example 2 includes the subject matter of example 1, and wherein the TSU is to cause the supply voltage to be adjusted by waking up the control unit to cause it to adjust the supply voltage based on the sensed temperature value.

Example 3 includes the subject matter of any of examples 1-2, and wherein the integrated circuit includes an interrupt line coupled between the TSU and control unit, the TSU to wake up the control unit by issuing an interrupt on the interrupt line.

Example 4 includes the subject matter of any of examples 1-3, and wherein the TSU is to cause the supply voltage to be adjusted by providing the sensed temperature value to a VR generating the supply voltage.

Example 5 includes the subject matter of any of examples 1-4, and wherein the TSU issues an interrupt to the VR to provide it with the sensed temperature value.

Example 6 includes the subject matter of any of examples 1-5, and wherein the control unit is coupled with the TSU to program it with at least one temperature threshold to determine if the sufficient change in the sensed temperature value occurs.

Example 7 includes the subject matter of any of examples 1-6, and wherein the at least one temperature threshold includes a low threshold value to cause the supply voltage to be increased when the sensed temperature value reaches or goes below the low threshold value.

Example 8 includes the subject matter of any of examples 1-7, and wherein the control unit increases the supply voltage in accordance with an inverse temperature dependency (ITD) voltage/temperature curve for transistors being supplied by the supply voltage.

Example 9 includes the subject matter of any of examples 1-8, and wherein the integrated circuit is a processor.

Example 10 includes the subject matter of any of examples 1-9, and wherein the processor has a display engine to be supplied with the supply voltage during a deep sleep state when the control unit is inactive.

Example 11 includes the subject matter of any of examples 1-10, and wherein the TSU includes multiple temperature sensor circuits disposed in the integrated circuit and logic to generate the sensed temperature value from some or all of the multiple temperature sensor circuits.

Example 12 includes the subject matter of any of examples 1-11, and wherein the TSU and control unit are disposed on the same die.

Example 13 is an apparatus that includes a thermal sense unit (TSU) having at least one temperature sensor circuit and logic to generate a sensed temperature value from the at least one temperature sensor circuit. The TSU has one or more signal lines to couple the TSU to a control unit to provide to it the sensed temperature value for controlling a supply voltage to a functional block. The TSU is to remain on to generate the sensed temperature value when the control unit is inactive, and the functional block is active.

Example 14 includes the subject matter of example 13, and wherein the one or more signal lines include an interrupt line to enable the TSU to assert an interrupt to activate the control unit when the sensed temperature value reaches or crosses a temperature threshold.

Example 15 includes the subject matter of any of examples 13-14, and wherein the control unit is to program the TSU with the temperature threshold prior to being inactive.

Example 16 includes the subject matter of any of examples 13-15, and wherein the temperature threshold is a low threshold that causes the control unit to become active when the sensed temperature value goes below it.

Example 17 includes the subject matter of any of examples 13-16, and wherein the temperature threshold is part of a threshold range having an upper and a lower limit.

Example 18 includes the subject matter of any of examples 13-17, and wherein the TSU and control unit are part of a processor.

Example 19 includes the subject matter of any of examples 13-18, and wherein the TSU is located on a separate die from the control unit.

Example 20 includes the subject matter of any of examples 13-19, and wherein the functional block and control unit are part of a common power domain.

Example 21 includes the subject matter of any of examples 13-20, and wherein the TSU is to couple the sensed temperature value to a VR generating the supply voltage when the control unit is inactive.

Example 22 is a computing system that includes a processor, a control unit, and a voltage regulator. The processor has a thermal sense unit (TSU) to sense a temperature value. The control unit is coupled to the TSU to control a supply voltage based on the sensed temperature value when the control unit is active. The TSU is to cause the supply voltage to be adjusted to compensate for a sufficient change in the sensed temperature value when the control unit is inactive. The voltage regulator (VR) is coupled to the control unit to generate the supply voltage.

Example 23 includes the subject matter of example 22, and wherein the processor includes a functional block having a supply input coupled to the VR to receive the supply voltage.

Example 24 includes the subject matter of any of examples 22-23, and further comprises a battery to provide power to the VR from which it generates the supply voltage.

Example 25 includes the subject matter of any of examples 22-24, and wherein the TSU is to cause the supply voltage to be adjusted by waking up the control unit to cause it to adjust the supply voltage based on the sensed temperature value.

Example 26 includes the subject matter of any of examples 22-25, and wherein the processor includes an interrupt line coupled between the TSU and control unit, the TSU to wake up the control unit by issuing an interrupt on the interrupt line.

Example 27 includes the subject matter of any of examples 22-26, and wherein the TSU is to cause the supply voltage to be adjusted by providing the sensed temperature value to the VR.

Example 28 includes the subject matter of any of examples 22-27, and wherein the TSU issues an interrupt to the VR to provide it with the sensed temperature value.

Example 29 includes the subject matter of any of examples 22-28, and wherein the control unit is coupled with the TSU to program it with at least one temperature threshold to determine if the sufficient change in the sensed temperature value occurs.

Example 30 includes the subject matter of any of examples 22-29, and wherein the at least one temperature threshold includes a low threshold value to cause the supply voltage to be increased when the sensed temperature value reaches or goes below the low threshold value.

Example 31 includes the subject matter of any of examples 22-30, and wherein the control unit increases the supply voltage in accordance with an inverse temperature dependency (ITD) voltage/temperature curve for transistors being supplied by the supply voltage.

Example 32 is a computer readable storage medium that has instructions that when executed in a control unit cause the control unit to perform a method. The method includes reading a sensed temperature value from a thermal sense unit (TSU), controlling a supply voltage based on the sensed temperature value, programming the TSU with at least one temperature threshold, entering a reduced power state, waking from the reduced power state in response to an interrupt from the TSU, and updating the supply voltage based on a newly read sensed temperature value from the TSU.

Example 33 includes the subject matter of example 32, and wherein the method further comprises updating the at least one temperature threshold in the TSU after waking from the reduced power state.

Example 34 includes the subject matter of any of examples 32-33, and wherein updating the supply voltage based on the sensed temperature value includes compensating for an inverse temperature dependency (ITD) effect using a programmed relationship between temperature and required compensating offset voltage.

Example 35 includes the subject matter of any of examples 32-34, and wherein programming the TSU with at least one temperature threshold includes programming upper and lower threshold levels.

Example 36 includes the subject matter of any of examples 32-35, and wherein the method further comprises reducing the controlled supply voltage prior to entering the reduced power state.

Example 37 includes the subject matter of any of examples 32-36, and wherein the method further comprises handing off control of the supply voltage to the TSU before entering the reduced power state.

### Definitions

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “circuit” or “module” may refer to one or more passive and/or active components that are arranged to cooperate with one another to provide a desired function. Different circuits or modules may share ore even consist of common components. for example, A controller circuit may be a circuit to perform a first function and at the same time, the same controller circuit may also be a circuit to perform another function, related or not related to the first function.

The term “signal” may refer to at least one current signal, voltage signal, magnetic signal, or data/clock signal. The meaning of “a,” “an,” and “the” include plural references. The meaning of “in” includes “in” and “on.”

The terms “substantially,” “close,” “approximately,” “near,” and “about,” generally refer to being within +/−10% of a target value.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

It is pointed out that those elements of the figures having the same reference numbers (or names) as the elements of any other figure can operate or function in any manner similar to that described but are not limited to such.

For purposes of the embodiments, the transistors in various circuits and logic blocks described here are metal oxide semiconductor (MOS) transistors or their derivatives, where the MOS transistors include drain, source, and gate terminals. The transistors and/or the MOS transistor derivatives also include Tri-Gate and FinFET transistors, Gate All Around (GAA) Transistors including Square Wire or Rectangular Ribbon GAA Transistors, ferroelectric FET (FeFETs), or other devices implementing transistor functionality like carbon nanotubes or spintronic devices. Those skilled in the art will appreciate that other transistors, for example, Bi-polar junction transistors (BJT PNP/NPN), BICMOS, CMOS, GaN, etc., may be used without departing from the scope of the disclosure.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are dependent upon the platform within which the present disclosure is to be implemented.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. An apparatus, comprising:
a thermal sense unit circuit (TSU) to generate a sensed temperature value; and
a control unit circuit coupled to the TSU to control a supply voltage based on the sensed temperature value, the TSU to cause the supply voltage to be adjusted to compensate for a sufficient change in the sensed temperature value when the control unit circuit is not controlling the supply voltage during a reduced power state.

2. The apparatus of claim 1, wherein the TSU is to cause the supply voltage to be adjusted by waking up the control unit circuit to cause it to adjust the supply voltage based on the sensed temperature value.

3. The apparatus of claim 2, comprising an interrupt line coupled between the TSU and control unit circuit, the TSU to wake up the control unit circuit by issuing an interrupt on the interrupt line.

4. The apparatus of claim 1, wherein the TSU is to cause the supply voltage to be adjusted by providing the sensed temperature value to a VR generating the supply voltage.

5. The apparatus of claim 4, wherein the TSU issues an interrupt to the VR to provide it with the sensed temperature value.

6. The apparatus of claim 1, wherein the control unit circuit is coupled with the TSU to program it with at least one temperature threshold to determine if the sufficient change in the sensed temperature value occurs.

7. The apparatus of claim 6, wherein the at least one temperature threshold includes a low threshold value to cause the supply voltage to be increased when the sensed temperature value reaches or goes below the low threshold value.

8. The apparatus of claim 7, wherein the control unit circuit increases the supply voltage in accordance with an inverse temperature dependency (ITD) voltage/temperature curve for transistors being supplied by the supply voltage.

9. The apparatus of claim 1, wherein the TSU and control unit circuit are part of an integrated circuit that is a processor.

10. The apparatus of claim 9, wherein the processor has a display engine to be supplied with the supply voltage during a deep sleep state when the control unit is inactive.

11. The apparatus of claim 9, wherein the TSU includes logic and multiple temperature sensor circuits disposed in the integrated circuit to generate the sensed temperature value from some or all of the multiple temperature sensor circuits.

12. The apparatus of claim 1, wherein the TSU and control unit circuit are disposed on a common die.

13. An apparatus, comprising:
a thermal sense unit (TSU) having at least one temperature sensor circuit and logic to generate a sensed temperature value from the at least one temperature sensor circuit, the TSU having one or more signal lines to couple the TSU to a control unit circuit to provide to it the sensed temperature value for controlling a supply voltage to a functional block;
wherein the TSU is to remain on to generate the sensed temperature value when the control unit circuit is inactive and the functional block is active.

14. The apparatus of claim 13, wherein the one or more signal lines include an interrupt line to enable the TSU to assert an interrupt to activate the control unit circuit when the sensed temperature value reaches or crosses a temperature threshold.

15. The apparatus of claim 14, wherein the control unit circuit is to program the TSU with the temperature threshold prior to being inactive.

16. The apparatus of claim 15, wherein the temperature threshold is a low threshold that causes the control unit circuit to become active when the sensed temperature value goes below it.

17. The apparatus of claim 15, wherein the temperature threshold is part of a threshold range having an upper and a lower limit.

18. A computing system, comprising:
a processor having a thermal sense unit (TSU) to sense a temperature value;
a control unit circuit coupled to the TSU to control a supply voltage based on the sensed temperature value when the control unit circuit is active, the TSU to cause the supply voltage to be adjusted to compensate for a sufficient change in the sensed temperature value when the control unit circuit is inactive; and
a voltage regulator (VR) coupled to the control unit circuit to generate the supply voltage.

19. The system of claim 18, wherein the processor includes a functional block having a supply input coupled to the VR to receive the supply voltage.

20. The system of claim 18, further comprising a battery to provide power to the VR from which it generates the supply voltage.
